(19) United States
(12) Patent Application Publication
(10) Pub. No.: US 2024/0158240 A1
(43) Pub. Date: May 16, 2024

(54) SYSTEM FOR SOL-GEL PROCESS CONTROL USING ELECTROMAGNETIC FIELDS AND METHODS THEREOF

(71) Applicant: UNM RAINFOREST INNOVATIONS, Albuquerque, NM (US)

(72) Inventor: Jonathan Carter HEBERT, Albuquerque, NM (US)

(73) Assignee: UNM RAINFOREST INNOVATIONS, Albuquerque, NM (US)

(21) Appl. No.: 18/569,427

(22) PCT Filed: Jul. 15, 2022
(86) PCT No.: PCT/US2022/037281

§ 371 Date: Dec. 12, 2023

Related U.S. Application Data
(60) Provisional application No. 63/273,219, filed on Oct. 29, 2021.
(60) Provisional application No. 63/222,518, filed on Jul. 16, 2021.

(51) Int. Cl. C01B 33/14; B01J 19/08; B82Y 30/00; B82Y 40/00

(52) U.S. Cl. CPC C01B 33/14; B01J 19/087; B01J 2219/0815; B82Y 30/00; B82Y 40/00; C01P 2004/64

(57) ABSTRACT

A method of producing nanomaterials in a sol-gel process is described, including selecting at least one type of nanoparticle to be produced within a prepared solution, placing high voltage contactless electrodes in a pre-selected configuration that forms the selected at least one type of nanoparticle, the high voltage contactless electrodes includes at least one anode and one cathode, providing the prepared solution for application of an electric field via high voltage contactless electrodes without direct contact with the anode and the cathode, and providing a voltage to the high voltage contactless electrodes, and producing the at least one type of nanoparticle within the prepared solution. A method of controlling production of nanomaterials in a sol-gel process and a system for producing nanomaterials having high voltage contactless electrodes is disclosed.

### Cross Reference to Related Applications

This application is a U.S. National Phase application of PCT/US2022/037281 filed Jul. 15, 2022, which claims priority to U.S. 63/222,518, filed on Jul. 16, 2021 and U.S. 63/273,219, filed on Oct. 29, 2021, the disclosures of which are incorporated by reference herein in their entireties.

### TECHNICAL FIELD

The present teachings relate generally to free-standing structured organic films and, more particularly, to compositions for anionic exchange membranes containing imidazolium compounds formed from free-standing structured organic films.

### BACKGROUND

Sol-gel chemistry is an active research field with broad medical and industrial applications ranging from pharmaceutical delivery systems to optical coatings. There are known studies that relate to electric field effects on crystal growth colloid aggregation and surface interactions. For example, electric fields have been known to influence crystal nucleation. Crystal nucleation rate of metal-organic compound bis-thiourea zinc chloride (ZTC) increases with an applied DC electric field. Glucose isomerase crystals grown with an applied DC electric field have been shown to be larger, of higher quality, and had fewer nucleation sites. Crystal growth rates in these instances are functionals of interfacial surface concentration of chemical species.

The sol-gel process is an ion mediated wet chemical materials synthesis method capable of producing uniform nanoparticles, glasses, ceramic, fibers, aerogels, and membranes, involving a base catalyzed reaction with, as an example, a silicon precursor tetraethyl orthosilicate (TEOS). The sol-gel process is also applicable to a wide variety of material compositions and application. The “sol”, which is a colloidal solution, is condensed to form a gel-like network that contains both a liquid phase and a solid phase. The “gels” are networks of silica species of various densities.

Silica sol-gel formation is an example of a biform combination of the hydrolysis and condensation bimolecular nucleophilic substitution reactions of silanols. Acid catalyzed silanol polymerization occurs indirectly via nucleophilic displacement of hydroxyl (OH) and alkoxyl (RO) ligands where electron density is withdrawn from silicon and susceptible to protonation. Base catalyzed silanol polymerization occurs via direct deprotonation of silanol at the sites of greatest condensation with electron density is closely bound to silicon. Silicon electron density decreases ≡Si—R>≡Si—OR>≡Si—OH>≡Si—O—Si≡ and the electron density is likely to be the greatest at the ends of monomers and oligomers.

DC and AC electric fields have been shown to induce patterns of colloidal aggregation on electrodes in electrolyte solutions. However, the precise mechanisms of colloidal aggregation and pattern formation remain debated or without relation to electric field geometry. It has been suggested that an applied electric field may induce fluid flow fields axially symmetric to colloids drawing nearby colloids into their vicinity via a vortex effect. It has also been suggested that electric field induced electrohydrodynamic flow can influence colloidal aggregation. Other work has suggested that an AC electric field induces colloidal aggregation by triggering a type of attractive and repulsive sorting of dipole forces, where electric field jostling of colloids separates some and aggregates others. It has also been proposed that rather than electric field induced flow, the electric field enhances dipole-dipole colloidal interaction energies resulting in chaining and aggregation.

Therefore, a sol-gel process and system for applying electromagnetic fields to a sol-gel precursor solution or composition would be of significant interest.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

The present disclosure provides a method of producing nanomaterials in a sol-gel process. The method of producing nanomaterials includes selecting at least one type of nanoparticle to be produced within a prepared solution, placing high voltage contactless electrodes in a pre-selected configuration that forms the selected at least one type of nanoparticle, the high voltage contactless electrodes includes at least one anode and one cathode, providing the prepared solution for application of an electric field via high voltage contactless electrodes without direct contact with the anode and the cathode, and providing a voltage to the high voltage contactless electrodes, and producing the at least one type of nanoparticle within the prepared solution. Implementations of the method of producing nanomaterials may include where the at least one type of nanoparticle is a nanorod. The at least one type of nanoparticle may include silicon dioxide or iron oxide. The pre-selected configuration of high voltage contactless electrodes is a transverse electric field configuration or a perpendicular electric field configuration.

A method of controlling production of nanomaterials in a sol-gel process is disclosed. The method of controlling production of nanomaterials includes providing an electric field control device having an anode and a cathode, exerting an electric field via the electric field control device to a colloidal solution without having direct physical contact between the anode and cathode to the colloidal solution, and forming nanoparticles in the colloidal solution. Implementations of the method of controlling production of nanomaterials may include where the electric field control device is high voltage contactless electrodes in a transverse electric field configuration. The electric field control device can alternatively be high voltage contactless electrodes in a perpendicular electric field configuration. The nanomaterial is a plurality of nanorods. The nanomaterial may include silicon dioxide, iron oxide, or a combination thereof.

A system for producing nanomaterials having high voltage contactless electrodes is disclosed, which may include a high voltage power supply, an anode connected to the high voltage power supply, and a cathode connected to the high voltage power supply. The system for producing nanomaterials also includes a reaction vessel configured to contain a reaction media, and a dielectric media between the high voltage contactless electrodes and the reaction vessel. Implementations of the system for producing nanomaterials may include where the dielectric media is air. The anode and cathode can be arranged perpendicular to the reaction vessel. The anode and cathode can be arranged on opposite sides of the reaction vessel. The system for producing nanomaterials may include an array of anodes, and an array of cathodes. The high voltage power supply emits an electric field from about 400V/5.0 cm to about 6 kV/2.2 cm. The reaction media may include a sol gel precursor. The system for producing nanomaterials may include an agitation device. The agitation device can be a rotational stage, a translational stage, a stirring apparatus, or a combination thereof.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1A is a schematic of a system including high voltage contactless electrodes (HVE) in a dipole field configuration using non-invasive probes (electric field emitters) placed above a sol-gel reaction vessel, in accordance with the present disclosure.

FIG. 1B is a schematic of a magnified portion of the system including high voltage contactless electrodes (HVE) in a dipole field configuration using non-invasive probes (electric field emitters) placed above a sol-gel reaction vessel of FIG. 1B, in accordance with the present disclosure.

FIG. 2 is schematic of a system including high voltage contactless electrodes (HVE) in a uniform electric field configuration using non-invasive methods, in accordance with the present disclosure.

FIGS. 3A-3F depict a series of charts depicting computer simulations used to predict and describe an example of one or more isopotential surfaces, generated when applying a field to a solution, in accordance with the present disclosure.

FIG. 4 depicts a chart describing a local neutral band (LNB) between antipodal sol surfaces of potential, in accordance with the present disclosure.

FIG. 5 depicts a chart describing the nature of solubility and charge mobility between two isopotential surfaces, in accordance with the present disclosure. [depicts a chart describing a nucleation manifold boundary (LNB) in between spaces is described as the nucleate space, in accordance with the present disclosure.]

FIG. 6 is a graph describing a model of biform sol-gel functionality as HVE induced sol-gel potential ψₛ in terms of LNB manifold solubility Σ_{L}=n_{∂L}^{o}/ρ∂L^{o} as the ratio of number nucleate density to number charge density.

FIG. 7 is a contour plot of nucleation potential as LNB boundary ∂L interior angle derivative ∂θ as HVE induced potential ψₛ and number nucleate density n_{∂L}^{o} as size a. HVE induced sol-gel potential ψₛ patterns solubility pair structures exhibiting regions of high nucleate potential adjacent to regions of low nucleate potential, in accordance with the present disclosure.

FIGS. 8A-8F are a series of graphs illustrating the effects of HVE dipole on/off and switch polarity for an example utilizing high voltage contactless electrodes (HVE) in a dipole field configuration using non-invasive probes (electric field emitters), in accordance with the present disclosure.

It should be noted that some details of the figures have been simplified and are drawn to facilitate understanding of the present teachings rather than to maintain strict structural accuracy, detail, and scale.

### DETAILED DESCRIPTION

Sol-gel formation mechanisms are thoroughly described by Brinker, Scherer (Brinker & Schere, 1990), and Iler (Iler, 1979). Solubility and pH are intrinsic to sol-gel form. Acidic conditions (pH<2) prevent reesterfication of hydroxide (OH) and alkoxyl (RO) ligands after formation resulting in weakly branched polymerization sol-gel form. Polymerization occurs indirectly via nucleophilic displacement of hydroxide (OH) and alkoxyl (RO) ligands where electron density is withdrawn from silicon and susceptible to protonation. Silica is insoluble at low pH and produces three-dimensional polymer networks unable to rearrange into particles (Brinker & Schere, 1990). Low dissolution rate of hydroxide and alkoxyl ligands corresponds to low pH, silica insolubility, and inability for siloxane bonds once formed to be hydrolyzed. Basic condition (pH>2) sol-gel polymerization is characteristically highly branched where growth occurs via direct deprotonation of silanol at the sites of greatest condensation with electron density closely bound to silicon. High dissolution rate at high pH corresponds to silica particle formation through ripening, reorganization of silanol polymers via hydrolysis and reesterfication, and silica solubility (Iler, 1979). Sol-gel polymerization is especially sensitivity to pH near the isoelectric point of two. Small changes in pH in this region can drastically impact solubility, dissolution, and condensation rates resulting in different sol-gel forms.

High voltage contactless electrodes (HVE) have been shown to induce biform sol-gel nucleophilic substitutions reactions conditions by redistribution of charge density. HVE sol-gel charge density redistribution is without need of inserting probes or electrodes into solution. Contactless application of high voltage electrodes localizes sol-gel formation patterned by natural biform nucleophilic substitutions in acidic and basic conditions. Silica sol-gel form is sensitive to ion concentration (pH), molar ratios of silicone alkoxide, catalysts, and solvent; all respond to HVE. The present disclosure provides a system and method for applying electromagnetic fields to a sol-gel precursor solution or composition to localize sol-gel reaction conditions. Non-invasive electric fields can be used to localize sol-gel reaction conditions without inserting electrodes into the solution, such as placing strong electrodes above a solution without contact. By applying a strong electric field gradient to a sol-gel solution without inserting probes into the solution during condensation, the space charge density of ion reactants can be localized in such a manner that would change the resulting chemistry and silica products that form from the condensation.

HVE redistribution of charge density as provide herein will additionally influence sol-gel form. For example, HVE redistribution can concentrate ions, deform EDL (electric double layer), and change reactant solubility. In exemplary examples, HVE redistribution of charge density can enable the formation of stratified layers of charge density along isopotential layers and enhance axial polymerization and colloidal chaining.

HVE functionalizes sol-gel kinetic diffusion and reaction limited polymerization as induced pseudo interfacial surface charge covariant derivative ∇σ_{∝M}=ρ_{M}. HVE redistributes sol-gel ions into stratified charge density layers. Local neutral band bands occur in-between charge density strata. Local neutral boundary ∂L in HVE induced manifold L is a pseudo interfacial surface. Characteristic geometry of local neutral band express HVE patterned depletion areas. Variations of pseudo interfacial surface density are expressed as a projection in local neutral bands.

Further descriptions of HVE impact on sol-gel formation can be provided by experiments and modeling of contactless application of high voltage electric fields on the sol-gel process form the basis using a mathematical construction. This approach uses intermolecular electrostatics, Poisson-Boltzmann equation (PBE), electrical field divergence on Riemannian surfaces, interfacial surface forces, and mechanisms of sol-gel polymerization described by Brinker, Scherer (Brinker & Schere, 1990), and Iler (Iler, 1979). Qualitative nanoscale analysis utilizes extensive electron microscopy imaging of the sol-gel products and electrochemical potential mapping device (PotMap) measurements. MATLAB can be used to solve PBE and process in-situ measurements. Numerous sol-gel Stober, mesoporous nanoparticle (NP), and thin film synthesis experiments have been performed using HVE and PotMap and are described herein.

Variations in the electric field intensity and shape in the sol-gel solution during condensation can be used to modulate the products of formation. For example, applying a transverse (or uniform) electric field to the sol-gel solution produces stratification of reactant intermediaries and acts as a filter along stratified layers of space charge that form along isopotential surfaces. Experiments with controlling or configuring a transverse electric field in sol-gel films consistently produce stratification of space charge densities producing fossilization of the electric filed pattern in the silica products. Applying a perpendicular electric field to a thin film sol-gel solution produces rapid formation and growth of nanorods. Experiments with perpendicular or uniform electric field configuration in sol-gel films produces mono disperse nanorod growth within seconds, and within minutes the nanorods can be seen with the naked eye. The non-invasive sol-gel process can produce dramatically different silica products with less than a millimeter scale of separation between the silica products in the same reaction vessel.

The non-invasive sol-gel process has numerous industrial and biomedical applications, ranging from manufacturing of nanorods sensors, chemical species filtering for labs on a chip, to nanoparticle morphology enhancements, such as surfactant templating, Janus particles, and directed anisotropic growth. Using strong, non-invasive electric fields to modulate the chemical synthesis process can be broadly applicable to industrial and biomedical processes, beyond sol-gels. The use of strong and localized electric fields without the use of invasive electrodes that change the chemistry of the solution is now made economically viable with the modern high voltage power supplies and high-speed switching circuitry.

Sols are colloids. Gels are networks of silica species of varying densities, e.g., ramified network of polymeric silica weakly cross-linked, or dense networks, highly branched, with extensive concentrations of dimeric silica. As an example, a silica sol-gel process is governed by two distinct chemical reactions: hydrolysis of a silicone alkoxide precursor such as TEOS (Si(OEt)₄), and condensation of polymeric siloxane (Si—O—Si) by the elimination of water or alcohol via deprotonation silanol groups from orthosilicic acid (Si(OH)₄), oligomers, and sols, or colloids.

Silica and surfactant solubility in the case of templated synthesis can be key factors in the aggregation kinetics that dominate sol-gel formation. Sol growth rates, flocculation, configuration entropy, packing, and chaining are driven by solubility and steric effects. Acid and base catalyzed sol-gels reactions can produce ramified or densely branched networks of polymeric silica, respectively. Biform sol-gels are functionals of bimolecular nucleophilic substitutions that occur during silanol polymerization. Nucleophilic substitution mode is catalyst pH coordinated for both hydrolysis and condensation. Silanol chain electron availability is low at transverse sol boundary and high at axil sol boundary. Acid catalyzed silanol polymerization occurs indirectly by protonation of a hydroxide or alkoxide ligand where electron density has been pulled back from silicon and made ready a leaving group. Conversely, basic catalyzed polymerization occurs via direct deprotonation in electron poor regions of highly branched silanol. Transverse polymerization dominates sol-gel basic form. pH is not well defined non-aqueous solutions and ethanol is the primary solvent used in this research. Charge density distributions in solution can be used to describe pH effects on sol-gel form. Biform silica polymerization is a functional of oligomeric electron density geometries, sol charge, silica solubility, solvent and catalyst concentration, pH, and reactant availability. Sol-gel products are biform characteristic functional expressions of HVE. Acid catalyzed hydrolysis occurs rapidly. Depolymerization is unlikely in acidic conditions. Base catalyzed hydrolysis happens continually and is a reversable process and may be impacted by an applied electric field. For example, the reaction schemes (1) and (2) below represent such reactions:

≡Si—EtO+H2O [symbol] ≡Si—OH+EtOH (1)

≡Si—EtO+H30O+ [symbol] ≡Si—OH2+ +EtOH (highly acid conditions) (2)

In a sol-gel acid catalyzed reaction, condensation is likely to be impacted by an applied electric field. Protonation of alkoxide or hydroxide ligand facilitates polymerization and condensation:

≡Si—EtO+HO—Si≡OH [symbol] ≡Si—O—Si≡+EtOH (alcohol condensation) (3)

≡Si—OH+HO—Si≡OH [symbol] Si—O—Si≡+H2O (water condensation) (4)

Condensation occurs during the aggregation and polymerization of oligomeric silica. Ramified silica forms in acidic conditions that are labile proton rich conditions, where siloxane bond reesterfication is unlikely and hydration layers reduce configuration. Condensation eliminates water or alcohol via silanol group deprotonation of orthosilicic acid (Si(OH)₄) ligands, and protonation of hydroxo and alkoxide oligomers and sols (colloids). Protonation occurs at the site of with greatest available electron density. Ligands withdraw electron density from silicon producing better leaving groups.

Sol-gel catalyst sets the pH and condensation rate. Sol-gel condensation occurs slowly at a pH of 2 near the isoelectric point of silica. Silica species are positively charged at pH below the isoelectric point (acid-catalyzed) and negatively charged above pH of 2 (base catalyzed).

In a sol-gel base catalyzed reaction, silica sols form in basic conditions slowly where solute silica esterification and reesterfication allow restructuring to occur. Basic catalyzed sol-gel forms dense oligomeric structures with higher condensation degree. Ostwald ripening occurs in basic conditions and charge stabilization generally keeps sols from aggregating. Base catalyzed condensation occurs by a SN2-type bimolecular mechanism starting with nucleophilic attack by the anion hydroxide OH— on a hydroxide ligand, eliminating water and forming the ≡Si—O— anion. Then the nucleophile ≡Si— O— subsequently attacks the alkoxide ligand and forms a new siloxane bond:

OH—+HO—Si≡ [symbol] ≡Si—O—+HOH (5)

≡Si—O—+Si(OR)4 [symbol] ≡Si—O—Si≡+RO (6)

Nucleophilic attack occurs at the site of least electron density. Silicon electron density decreases as ≡Si—R>≡Si—OR>≡Si—OH>≡Si—O—Si≡. Polymerization in basic conditions favors highly condensed siloxane species where there is low electron density. Sol-gel condensation in basic conditions will lead to polymerization in the middle of silanol chains and result in densely branched products.

To produce an electric field strong enough to noticeably impact sol-gel formation, the use of a High Voltage Contactless Electrode (HVE) is provided. HVE can produce electric field intensities of 7.0 kV/2.2 cm with 7000 VDC. HVE generates large DC electric fields. Two primary HVE configurations according to the present disclosure are dipole and uniform, although other configurations are applicable. HVE intensities of 400V/7.0 cm are known to impact sol-gel formation. Any combination of HVE application modulation timing, duration, frequency, electric field shape/orientation/polarization, number of electric field poles, and electric field intensity produce characteristically unique sol-gel forms. HVE works with AC and DC electric fields. HVE modulates sol-gel form at scales ranging from lab on a chip (micro-liter) to industrial (liter) scales. Dipole and uniform HVE configurations demonstrate how electric field shape/orientation impact sol-gel form.

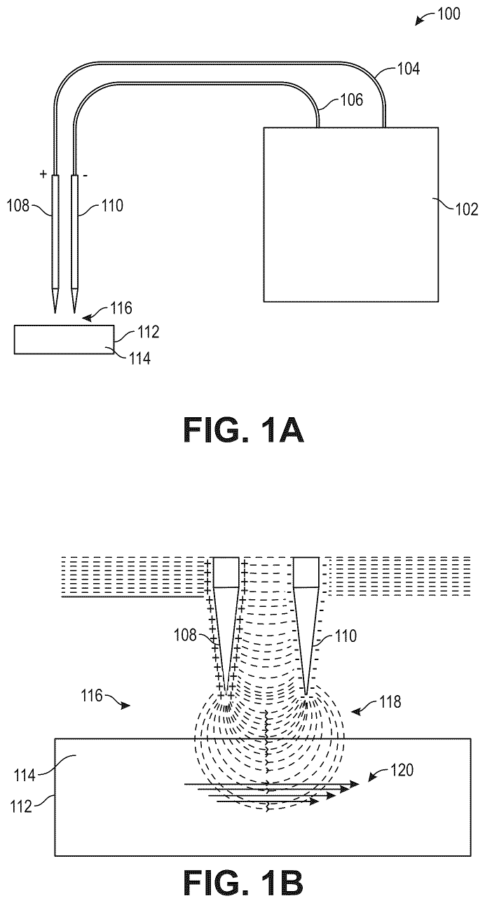

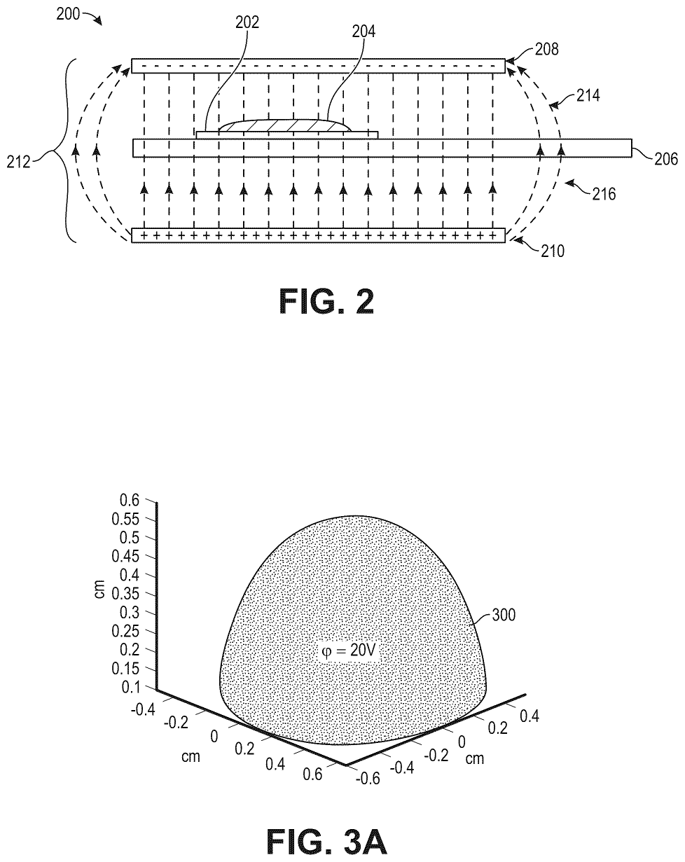

FIG. 1A is a schematic of a system including high voltage contactless electrodes (HVE) in a dipole field configuration using non-invasive probes (electric field emitters) placed above a sol-gel reaction vessel, in accordance with the present disclosure. A dipole field configuration HVE system 100 is shown, having a high voltage DC power supply 102. The electromagnetic field control device, or dipole field configuration HVE system 100 further including the high voltage DC power supply 102 includes a positive emitter connector 104 and a negative emitter connector 106 are attached to a positive emitter 108 or anode and a negative emitter 110 or cathode, respectively. The positive emitter 108 and negative emitter 110 are shown directed towards a top surface of a reaction vessel 112. The positive emitter 108 and negative emitter 110 are not in contact with the reaction vessel 112 or a quantity of a reaction media such as a sol-gel precursor composition 114 held within the reaction vessel 112. The positive emitter 108 and negative emitter 110 are separated from the reaction vessel 112 and the sol-gel precursor composition 114 by a dielectric media 116, which in this instance as shown, is an air gap. Other dielectric media can be employed in the system of FIG. 1A, such as glass, plastics, porcelain, ceramics, mineral oil, nitrogen, sulfur hexafluoride, electret, and special industrial coatings. A semi-conductor in dielectric mode can also be employed for HVE application. FIG. 1B is a schematic of a magnified portion of the system including high voltage contactless electrodes (HVE) in a dipole field configuration using non-invasive probes (electric field emitters) placed above a sol-gel reaction vessel of FIG. 1B, in accordance with the present disclosure. The ends of the positive emitter 108 and negative emitter 110 directed towards the sol-gel precursor composition 114 held in the reaction vessel 112 in a perpendicular orientation and separated by dielectric medium 116 is shown in higher magnification. The HVE dipole tips 108, 110 direct electric field E flux into sol-gel solution 114. Dipole HVE electric field lines 118, 120 are both normal and tangential to the air/sol-gel boundary. The HVE cathode 110 is highly negative [−600, −7000] VDC, and the anode 108 is 0 V. HVE redistributes charge density in the sol-gel composition 114 and induces formation of pseudo interfacial surfaces. The nature of the HVE pseudo interfacial surfaces can significantly impact the sol-gel process. This HVE dipole high voltage DC power supply with two closely positioned sharp electrodes provides a contactless pair of electrodes above sol-gel to direct an electric field into the solution. Additional portions of the system, such as voltmeter and high voltage probe are not shown for the purposes of clarity. HVE configuration mounting, scaffolding, and sol-gel reaction vessel are important aspects of the system that are not shown. HVE works for any sol-gel reaction vessel like a beaker, petri dish, nano-channel, tank, spin coater, pressure and temperature chamber, aerosol chamber, and the like.

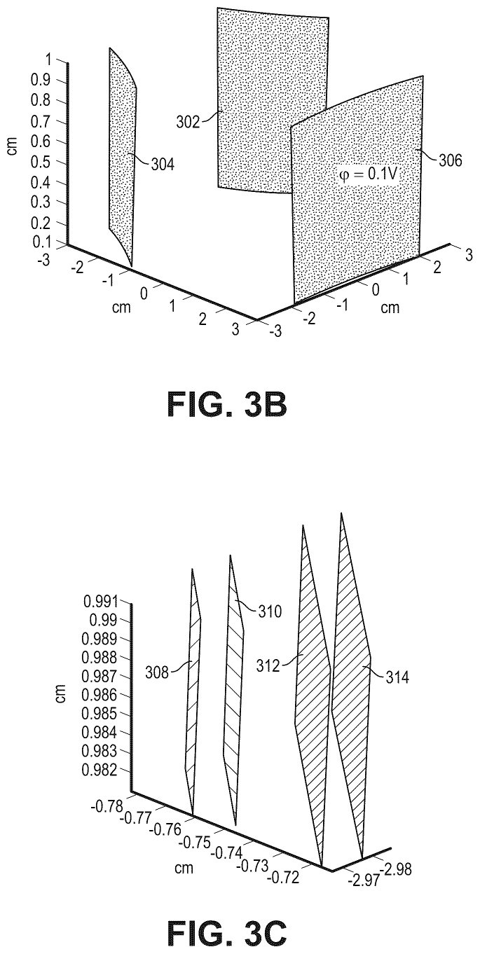

FIG. 2 is schematic of a system including high voltage contactless electrodes (HVE) in a uniform electric field configuration using non-invasive methods, in accordance with the present disclosure. A uniform field HVE system 200 is shown, with some of the power supply and other components not shown herein for the purposes of clarity. A substrate 202 is mounted upon a platform 206, the substrate 202 in this instance being a glass slide, although in alternative examples of such an electromagnetic field control device, other substrate materials can be used. Substrate must be a non-conductive dielectric or a semi-conductor in dielectric mode. Electric susceptibility, dispersion, and relaxation are substrate materials properties important to HVE application. On the substrate 202 is a sol-gel precursor composition 204. The platform 206 is also made of glass, although other materials may be applicable in certain examples. Any dielectric can serve as the substrate such as plastics, porcelain, ceramics, or electret. A semi-conductor in dielectric mode can serve as the HVE substrate. A negative emitter 208 or cathode is shown above the sol-gel precursor composition 204 and a positive emitter 210 or anode is shown below the sol-gel precursor composition 204, on opposite sides of the reaction vessel or substrate 202. In the HVE uniform field configuration of the negative emitter 208 and positive emitter 210 in a transverse position orients the electric field E perpendicular to the sol-gel composition 204 or prepared solution during condensation. The prepared sol-gel composition 204 is suspended on a glass substrate between HVE with the negatively charged cathode 208 above and anode 210 below. Electrodes 208, 210 are comprised of glass plates wrapped in copper mesh. Copper mesh is used to minimize weight on the apparatus while remaining stiff enough to stay in place during operation. Uniform HVE arrangement can orient acidic condition sol-gel polymerization into arrays of nucleates, inducing rapid nanorod array growth. HVE voltage, separation, substrate dielectric properties, and glass slide position 212 control LNB patterning orthogonal to the direction of the electric field, nucleation, and nanorod growth rate. Sol-gel nanorods grow toward the cathode with planar packing factor

$$\frac{\sqrt{V}}{x} ,$$

where V is HVE voltage and x is the distance from the cathode. Smaller packing factor means more nucleates/nanorods per unit area or less space between nucleates/nanorods. Larger packing factor means less nucleates/nanorods per unit area or more space between nucleates/nanorods. Electric field fringing 214 and 216 produce non-uniform LNB patterning near HVE and substrate edges. Glass slide/reaction vessel must be significantly smaller than HVE and substrate for uniform patterning. The high voltage power supply can produce voltages up to 75 kV. Though, HVE mount, scaffolding, substrate, and reaction vessel dielectric breakdown voltages limit applied field intensity. The example uniform field configuration can sustain voltages up to 6 kVDC. Applicable electric field intensity ranges for uniform configuration 400V/5.0 cm to about 6 kV/5.0 cm. HVE electric field intensities practical limitation for sol-gel chemistry is the breakdown voltage of the sol-gel precursor, solvents, and product. Sol-gel with ethanol solvent at risk of arching and catching fire at electric field intensities near 7.5 kV/2.2 cm.

It should be noted that systems as shown in FIGS. 1A, 1B, and 2 are exemplary in nature and that HVE systems of the present disclosure can have alternate configurations, such as the use of alternate vessels whether open or closed, used with spin coating, alternate contactless electrode (emitter) orientations, number of contactless electrodes, applications of electric fields oriented towards sol-gel solutions on a variety of surfaces, through different dielectric media, or having a variety of sol-gel precursor compositions. In addition, sol-gel compositions including multiple components or ingredients not limited to the examples herein, are considered in alternate examples. Dipole HVE produces extraordinary silica sol-gel tetrahedral and Janus nanoparticles with colloidal ferric oxide FeO(OH). HVE induces regions of high solubility near the contactless anode. HVE sol-gel form near anode is characterized by enhanced silica solubility, decreased silica concentration, increased configuration entropy, LNB broadening and EDL compression, reduced steric stabilization, decreased surface roughness, and reduced hydrogen bonding. Multi-surface Janus particles are created in HVE induced small regions of high solubility surrounded by regions of low ion mobility. Enhanced silica solubility produces highly condensed sol-gel polymerization with FeO(OH). Reduced ion mobility limits aggregation and keeps the ratio of nanoparticle surface area volume high. Janus particles complete formation after HVE is removed and silica condensation is complete. FeO(OH) is then ejected from the core silica polymer, leaving one half of the nanoparticle mostly FeO(OH) and the other half mostly silica shell. HVE can enhance or restrict surfactant packing in micellular, laminar, and fibrous mesoporous nanoparticles like Stober particles for the same reasons. HVE nanoparticle and thin film surface synthesis enables entropically unfavorable forms that even the most sophisticated chemical synthesis processes cannot reproduce. These entropically unfavorable nanoparticle and thin film silica forms are only possible using HVE pH, ion mobility, and solubility patterning. HVE application timing, duration, frequency, and electric field characteristics pattern sol-gel formation via solubility and ion mobility. HVE induces formation of local neutral band (LNB) of characteristic anodic and cathodic solubility regardless of the sol-gel precursor, because sol-gel formation is biform anodic or cathodic regardless. Anodic solubility conditions promote sol-gel polymerization by deprotonation. Cathodic solubility conditions promote sol-gel polymerization by protonation. LNB shape defines the nucleate potential tangent its interior angle derivative. HVE redistributes sol-gel ions into stratified charge density layers. Time varying HVE application can limit or promote ion mobility during sol-gel polymerization. Local neutral band (LNB) formation occurs in-between charge density strata. Manifold geometry of LNB express HVE patterned depletion areas from which sols ripen via soluble silanol oligomer surface nucleation. Variations of pseudo interfacial surface density are expressed as a projection of nucleate potential in HVE LNB.

Methods of producing nanomaterials in a sol-gel process of the present disclosure include determining at least one type of nanoparticle to be produced within a prepared sol-gel solution, placing a HVE in a pre-selected configuration that forms the selected at least one type of nanoparticle, where the HVE includes at least one anode and one cathode, providing the prepared solution to the HVE without direct contact with the anode and the cathode, and providing a voltage to HVE, and producing the at least one type of nanoparticle within the prepared solution. Nanorods produced according to the present disclosure can also be nanospheres, and other morphological shapes, including anisotropic nanoparticulate forms, such as but not limited to a plurality of nanorods, ellipses, platelets, and the like. Compositions of such nanomaterials can include silicon dioxide, iron oxide, combinations thereof, and the like. Enhanced silica gold, silver, and rare earth element composite nanomaterials can be synthesized using HVE. The present method and system further provide the exertion of an electromagnetic field to a colloidal solution without having direct physical contact between the anode and cathode to the colloidal solution and thus, forming nanoparticles in the colloidal solution. In certain examples, the method and systems of the present disclosure can incorporate an agitation device. Exemplary examples of an agitation device can include a rotational stage, a translational stage, a stirring apparatus, or a combination thereof. The agitation device is further configured for holding either a reaction vessel or sol-gel precursor composition during sol-gel processing or particle formation. In certain examples, more than one cathode or anode can be employed in a system or method of the present disclosure, such as, for example, an array of anodes, an array of cathodes, or a combination of both. While the two examples of orientations, the dipole orientation as shown in FIGS. 1A and 1B, and the uniform orientation as shown in FIG. 2 provide an example of contactless electric field effects directed into the solution or on either side of the solution, respectively, these two configurations could be considered as endpoints to demonstrate a full range of effective range. Alternatively, one or more antennae/emitters, or other electric field radiating electrode, could be used to make more specific patterns within the solution, and even practice electric field directed lithography of patterned chemical reactions. While sol-gel compositions are used as exemplary examples of the present disclosure, other chemical reactions could be used as well. For example, any reaction governed by a local change in solubility of reactants, pH, and ion mobility (how easily charged particles move throughout the solution), could be used in a system or method as described herein.

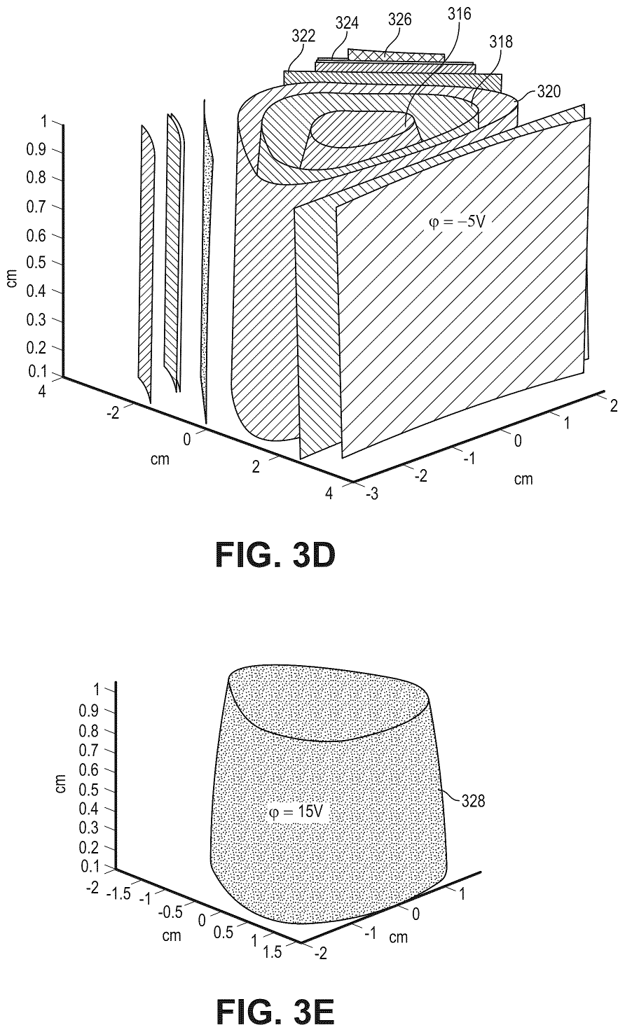

FIGS. 3A-3F depict a series of charts depicting computer simulations used to predict and describe an example of one or more isopotential surfaces, generated when applying a field to a solution, in accordance with the present disclosure. FIGS. 3A-3F represent various regions of quasi-charge-neutral sol-gel bulk occur in-between number charge density strata induced by HVE electric field flux divergence density, as applied by systems and methods of the present disclosure. Charge density strata express gradient potential zero vector boundaries ∇_{φ}_{_{∂M}}=0 along pseudo interfacial surfaces. Number charge density ρ_{∂L}^{o} aggregation structure characteristically express pseudo interfacial isopotential surfaces defined where the gradient potential is the zero vector ∇_{φ}_{_{∂L}}=0 in boundary ∂L in L: the local neutral band boundary. HVE induced local neutral boundary ∂L contains all level curves of local neutral potential _{φ}_{_{∂L}}=0 defined by geodesic isolines of potential αᵢ called geodesic isopotential lines. Discrete isopotentials are indicated with φ and continuum potentials are indicated with ψ.

Surface charge density of species with valency zₛ is ρₛ and is equal to the sum of the forces on the surface

$$S {■σ}_{s} = \frac{ε}{{z}_{s} e} {∮}_{S} 〈 F , n 〉 dS .$$

Therefore, similarly charged ionic species create pseudo interfacial isopotential surfaces under the contactless influence of an electric field. This results in sol-gel stratification along isopotential surfaces. A steric modified Poisson-Boltzmann equation (MPB) φ solution for a silica thin film synthesis demonstrates the formation of isopotential manifolds oriented orthogonal to electric field. Contour plots of HVE induced sol-gel isopotential surfaces are a topographic map of charge density ρ and reveal isopotential curvature as concentric charge density for various cp values. Areas of high isopotential curvature will form weakly branched sol-gels. Near HVE cathode high charge density will reduce configuration entropy and silica solubility. 1VIPB predicts larger magnitude voltage isopotentials show larger mean curvature cp and concentration charge density ρ-isopotentials near zero compacted together forming charge inverted strata. Inbetween antipodal strata exists a contium where ∇_{φ}_{_{∂L}}=0 and this is called the local neutral band boundary. FIG. 3A illustrates a set of MPB isopotentials of φ=20V 300, FIG. 3B represents φ=0.1V 302, 304, 306, FIG. 3C represents φ=−0.2V 308, −0.1V 310, +0.1V 312, +0.2V 314, FIG. 3D represents φ=17V 316, 10.13V 318, 5V 320, 0.5V 322, −0.1V 324, −0.5V 326 and FIG. 3E represents φ=15V 328. Isopotentials with a larger magnitude have greater spacing between their antipodal counter parts such as −5V and 5V.

The graphs shown in FIG. 3F of local diffuse charge density ρL in a steric modified Poisson-Boltzmann equation (MPB) HVE sol-gel shows the gradient potential zero vector ∇_{φ}_{_{∂L}}=0 in boundary ∂L at the peak of the gaussian distribution of charge density σ_{∂L}=max σ(∂L), as a simulation for applying a field to a sol-gel. When a static charge is applied, charge separates as a stratification, generating isopotential surfaces. This means that surface charge density is maximum starting at the local neutral band boundary and decreases as charge accumulates in the diffuse EDL or equivalently; as sol aggregation occurs surface area decreases. MBE indicates HVE induced isopotential formation creates local neutral bands (LNB) where free charge accumulates at the mean curvature 2H maximum.

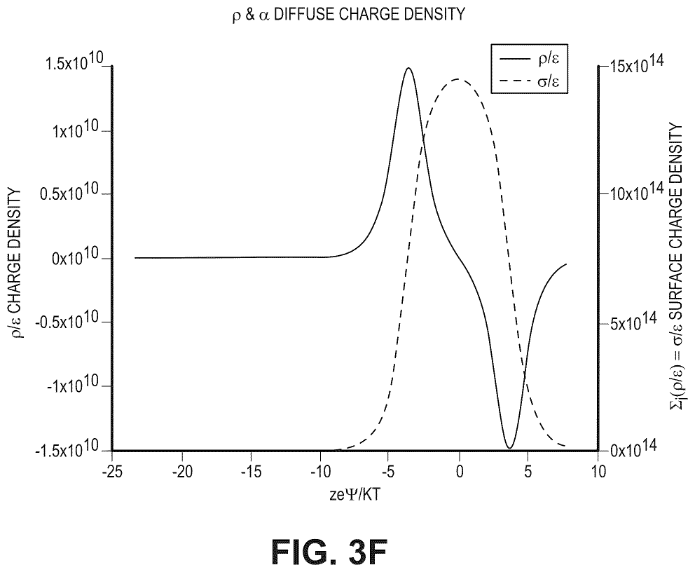

FIG. 4 depicts a chart describing a local neutral band (LNB) between antipodal sol surfaces of potential, in accordance with the present disclosure. LNB Manifold L is defined by HVE potential Ψ—Between Sol surfaces ±∂P (defining equal and opposite potentials) LNB is the ∇ψ=0 manifold—Boundary ∂L defines LNB differential shape—tan(θ)=∂L and tan(∂θ)=(∂L)² the nucleate potential—rate of change of interior angle θ is characteristic of the sol-gel form, either anodic or cathodic. Sol-gel biform functional f of LNB manifold solubility Σ_{L} is either boundary low ∂f_{C}^{o} or high ∂f_{A}^{o}. Cathode manifold solubility Σ_{C} is low. Anode manifold solubility Σ_{A} is high.

$$f ( {\sum }_{L} ) = \{ \begin{matrix}\partial {f}_{C}^{o} , & {\sum }_{L} = {\sum }_{C} > 0 \\ \partial {f}_{A}^{o} , & {\sum }_{L} = {\sum }_{A} \leq 0\end{matrix}$$

Sol-gel product form ∂f_{L} is the projection in boundary ∂L of manifold solubility Σ_{L} in LNB manifold L.

f: Σ_{L}→∂L

LNB manifold L is a pseudo interfacial surface defined in-between antipodal sol surfaces [−∂P, ∂P]. Solubility space N contains all LNB solubility spaces Σ_{L}_{ᵢ}. Manifold solubility is defined as the ratio of nucleate number density n_{∂L}^{o}:ρ_{∂L}^{o} to charge number density in boundary ∂L in LNB manifold L.

Σ_{L}=n_{∂L}^{o}=/ρ_{∂L}^{o}

This definition reinforces biform sol-gel as dual to cathodic (attracting positive charge—condensation by protonation) and anodic (attracting negative charge—condensation by deprotonation).

$$f ( \frac{{n}_{\partial L}^{o}}{{ρ}_{\partial L}^{o}} ) = \{ \begin{matrix}\partial {f}_{C} , & {n}_{\partial L}^{o} / {ρ}_{\partial L}^{o} > 0 & sol - gel cond . by protonation ( cathodic ) \\ \partial {f}_{A} , & {n}_{\partial L}^{o} / {ρ}_{\partial L}^{o} \leq 0 & sol - gel cond . by deprotonation ( anodic )\end{matrix}$$

Nucleate volume density n_{L}² in manifold L has n-1 differential form nucleate surface density n_{∂L}¹ and n-2 differential form nucleate number density n_{∂L}^{o} in boundary ∂L.

$${n}_{\partial L}^{o} = {\int }_{f} {n}_{L}^{2} = {n}_{L}^{1} = {\int }_{- \partial P}^{\partial P} {dn}_{\partial ( P - ( - P )}^{o} = {\int }_{\partial L} {dn}_{\partial L}^{o} = {\int }_{\partial L} ∇ {n}_{\partial L}^{o}$$

Nucleate density differential forms are related by integrals in manifold L and boundary ∂L.

$${n}_{\partial L}^{o} = {\int }_{\partial L} {n}_{\partial L}^{1} = {\int }_{L} {n}_{L}^{2}$$

Differential form notation implies n_{L}¹=n_{∂L}^{o}=∂n_{L}^{o}. Nucleate density is discrete in R³ and R² but continuous in manifold L. Intrinsic nucleate size a for steric MPB packing factor v=2a³ρ_{∂L}^{o} (Kilic, Bazant, & Ajdari, 2007) is characteristic to nucleate density forms [n_{∂L}^{o}, n_{∂L}¹, n_{∂L}²] as charge q is charge density forms [ρ_{∂L}^{o}, ρ_{∂L}¹, ρ_{∂L}²]. Nucleate number density n_{∂L}^{o} is a functional of electric potential and number charge density ρ_{∂L}^{o} in boundary ∂L. Steric 1VIPB displacement volume expression includes nucleate volume density n_{∂L}².

n_{L}²=4a³ρ_{∂K}^{o} sin h²(a ψ)

Nucleate volume density n_{L}² in L is in dimension a unit volume (2-form L) charge per ∂L. Because ∂L is a differential length (1-form) physically n_{L}² is the instantaneous volume size of a charge. Units of number charge density in ρ_{∂L}^{o} in boundary ∂L are charge per ∂L (or just differential charge). Simple cubic unit cell volume dimension a is the composite length of an effective ion and solvent molecule.

$${\sum }_{L} = {n}_{\partial L}^{o} / {ρ}_{\partial L}^{o} = ( \frac{1}{2} a cosh ( 2 a ψ ) - {a}^{3} {ψ}^{2} )$$

Sol-gel cathodic form is LN manifold boundary solubility low ∂f_{C}^{o}: weakly branched with high nucleate density n_{∂C}^{o}.
Sol-gel anodic form is LN manifold boundary solubility high of ∂f_{A}: highly branched with low nucleate density n_{∂A}^{o}.

Sol-gel functional f(RH(ψ)): ψ→[∂f_{C}, ∂f_{A}] of HVE polymerization functional RH(ψ) maps HVE induced sol-gel potential to cathodic and anodic forms. HVE field functional HR(ψ_{E}) maps HVE electrode potential ψ_{E} to sol-gel potential ψ_{S}, where:

HR: ψ_{E}→ψ_{S}

Sol-gel functional engineering as described herein, is a matter of constructing product form functionals f(RH(HR(ψ_{E})): ψ_{E}→[∂f_{C}, ∂f_{A}]. This means HVE applied field characteristics described as the potential from the electrodes ψ_{E} map directly to sol-gel formation as described by LNB manifold solubility.

Sol-gel multiform functional F is an n+1 differential form of biform sol-gel product functional f. Sol-gel functional f(U₁Σ_{C}+U₂Σ_{A}) of manifold solubility mixture U₁:U₂ expresses multiform as the sum of differential components of cathodic and anodic forms.

F(∂f_{U}_{₁}_{C}, ∂f_{U}_{₂}_{A})=F(f(U₁Σ_{C}+U₂Σ_{A}))=∂U₁∂f_{C}+∂U₂∂f_{A}

LNB solubility Mixture Σ(U)=n_{∂L}^{o}/ρ_{∂L}^{o}=L=U₁ΣE_{A}+U₂Σ_{C} is elliptical—LNB interior angle θ is defined between basis solubility vectors [Σ_{A}, Σ_{C}]. Elliptical LNB will express changes in nucleate potential along LNB—For constant curvature ∂θ=0 and LNB nucleate potential is constant.

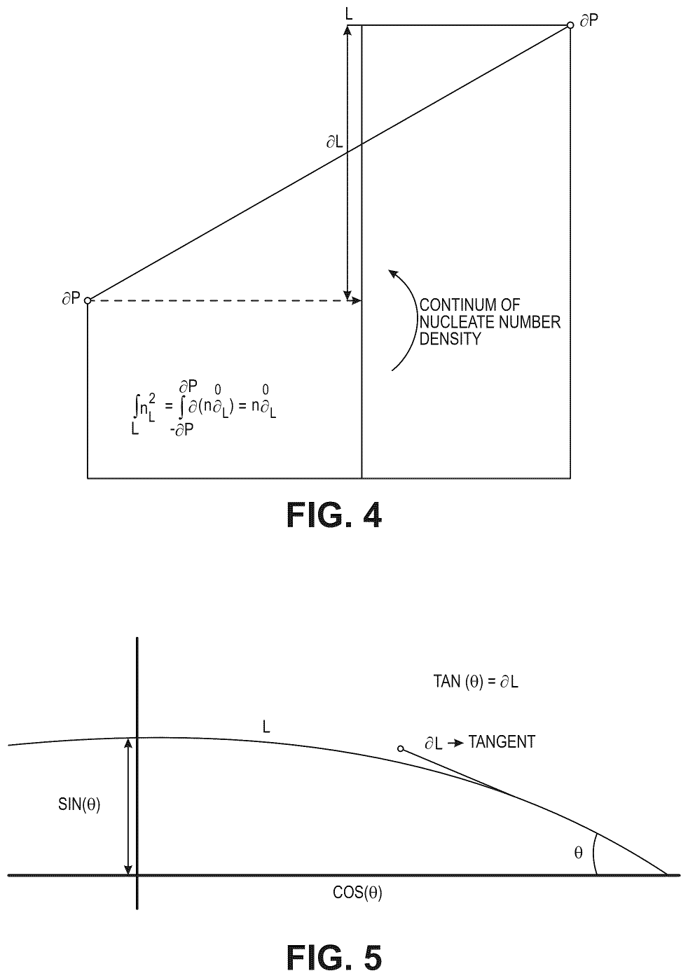

This therefore reflects sol-gel form functional intrinsic curvature dependence on solubility: consider the equation for a circle x²+y²=r². Unity solubility mixtures are constant curvature sol-gel functionals. Cathodic even and anodic odd mixtures are periodic curvature sol-gel functionals with pattern depletion. This demonstrates that between two isopotential surfaces, charge moves freely in a local neutral band, orienting itself and further describing how between these antipodal surfaces nucleation of particle formation occurs. The shape of the surfaces determines whether or not nucleation occurs. Geometric form HVE sol-gel functional existence can be further described as in FIG. 5. FIG. 5 depicts a chart describing the nature of solubility and charge mobility between two isopotential surfaces, in accordance with the present disclosure. LNB interior angle θ0 indicates the nature of HVE induced potential HR:ψ_{E}→ψ_{S} in sol-gel. Boundary ∂L=tan(θ) is tangent to manifold L and nucleate potential (likelihood of nucleation) is (∂L)²=tan(∂θ). Sharply bending LNB results in increased likelihood of nucleation opposite the interior angle and simultaneously a decreasing likelihood of nucleation adjacent the interior angle. Solubility boundary pairs [∂f_{C}, ∂f_{A}] form in HVE induced LNB. Formation of a region with high nucleation potential always produces an adjacent region of low nucleation potential. HVE potential ψ_{E} is modulated to induce characteristic sol-gel forms via patterning high and low solubility regions and limiting and inducing ion mobility. HVE field functional HR(ψ_{E}) control maps to induced sol-gel potential ψ_{S}. HVE polymerization functional RH(ψ_{S}) maps HVE induced sol-gel potential to cathodic and anodic forms [∂f_{C}, ∂f_{A}]. So, this provides a direct way to predict nucleate potential (∂L)² with respect to HVE application, spatially and in time.

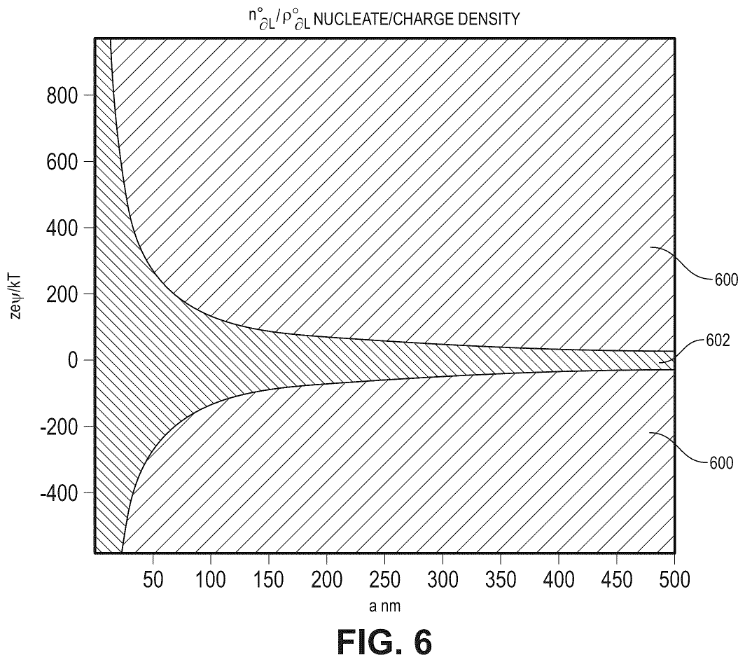

FIG. 6 is a graph describing a model of biform sol-gel functionality as HVE induced sol-gel potential O s in terms of LNB manifold solubility Σ_{L}=n_{∂L}^{o}/ρ_{∂L}^{o} as the ratio of number nucleate density to number charge density. LNB manifold solubility

$${\sum }_{L} = \frac{{n}_{\partial L}^{o}}{{ρ}_{\partial L}^{o}} = \frac{1}{2} a cosh ( 2 a ψ ) - {a}^{3} {ψ}^{2}$$

describes the number of nucleates of size a for sol-gel potential ψₛ. Sol-gel products are biform because their nature is dominated by solubility and dually whether they form by protonation or deprotonation. HVE process experiments in accordance with the present disclosure revealed biform sol-gel functionality regions cathodic 600 or anodic 602. Horizontal axis a in nm indicates the size of a nucleate. Vertical axis zeψ_{S}/kT is the energy of ionic species or sol-gel charge. Contour regions indicate solubility of size a nucleates Σ_{L}=n_{∂L}^{o}/ρ_{∂L}^{o} where there is a clear boundary between the cathodic (insoluble) and anodic (soluble) regions. HVE control of the ionic species energy via induced sol-gel potential ψₛ enables selection of the polymerization mechanisms. Using silane -based sol-gel as an example, in the cathodic domain 600, condensation proceeds by protonation, small nucleates form that are unlikely to undergo flocculation, and the sol-gel product will be weakly branched. In the anodic domain 602, condensation proceeds by deprotonation, small nucleates form and redissolve, grow by flocculation, and the sol-gel product will be highly branched.

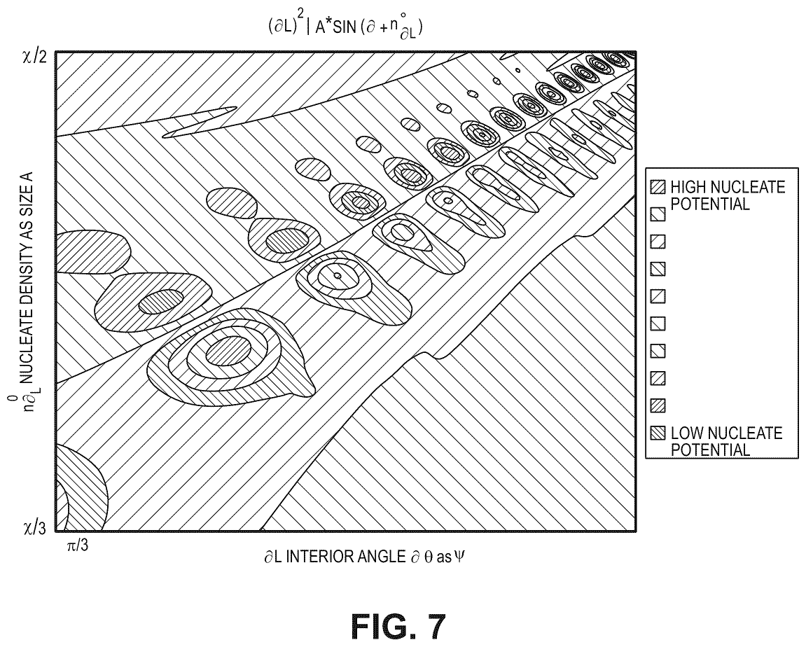

FIG. 7 is a contour plot of nucleation potential as LNB boundary aL interior angle derivative ∂θ as HVE induced potential ψₛ and number nucleate density n_{∂L}^{o} as size a. HVE induced sol-gel potential ψₛ patterns solubility pair structures exhibiting regions of high nucleate potential adjacent to regions of low nucleate potential, in accordance with the present disclosure. Regions having a high nucleate potential and regions have a low nucleate potential are indicated in FIG. 7. Sol-gel biform anodic (polymerization via deprotonation) and cathodic (polymerization via protonation) functionals can be added together. Addition of sol-gel biform functionals enables multiform construction of nucleate potentials possible with mixtures. HVE induces LNB shapes that when characterized by interior angle θ and interior angle derivative ∂θ all possible nucleate potentials can be realized. Furthermore, HVE induced nucleate potentials exhibit physically intuitive forms for both surface and bulk mixture angles. LNB mixture plots reveal solubility pair formation. Regions of high nucleate potential form adjacent to regions of low nucleate potential. Low nucleate potential regions are depletion regions from which adjacent high nucleate potential region ripening occurs. This relationship is akin to electron-hole pairs in solid-state semiconductors.

Nucleate potential (∂L)² can be described as a sinusoid of the interior angle derivative ∂θ and mixture angle Φ functional of potential ψ. Mixture angle Φ represents the mixture state U and can be defined arbitrarily to suit the mathematics. Exponential functions are well suited for potentials of electronic, chemical, and thermodynamic systems. Mixture state U=[U₁, U₂]=[sin(Φ), cos(Φ)] is a complex exponential, spherically coordinated, but can be refactored to need. Nucleate potential is periodic as expected for a mixture of ions/solvents with exponentially distributed concentrations.

(∂L)²=A sin(∂θ+Φ)

Nucleate potential amplitude is A=\sqrt{(sin Φ)²+(cos Φ)²}. If mixture angle Φ=n_{∂L}¹ then (∂L)² is the surface nucleate potential (probablity of nucleating on surface). If mixture angle Φ=n_{∂L}^{o} then (∂L)² is the number nucleate potential (probability of nucleating into number form). Mixture angle Φ can also be defined arbitrarily if it remains a functional of HVE induced potential ψ. Thus, physically intuitive nucleate potential shapes appear similar to colloidal dispersion forms. There are clearly boundaries, layers of nucleate potential shaped like an EDL, and copairing of solubility regions, as shown in FIG. 7. By sweeping the parameter space of a, ∂θ, and ψ, it yields a host of viable solubility pair structures which are likely to form by HVE.

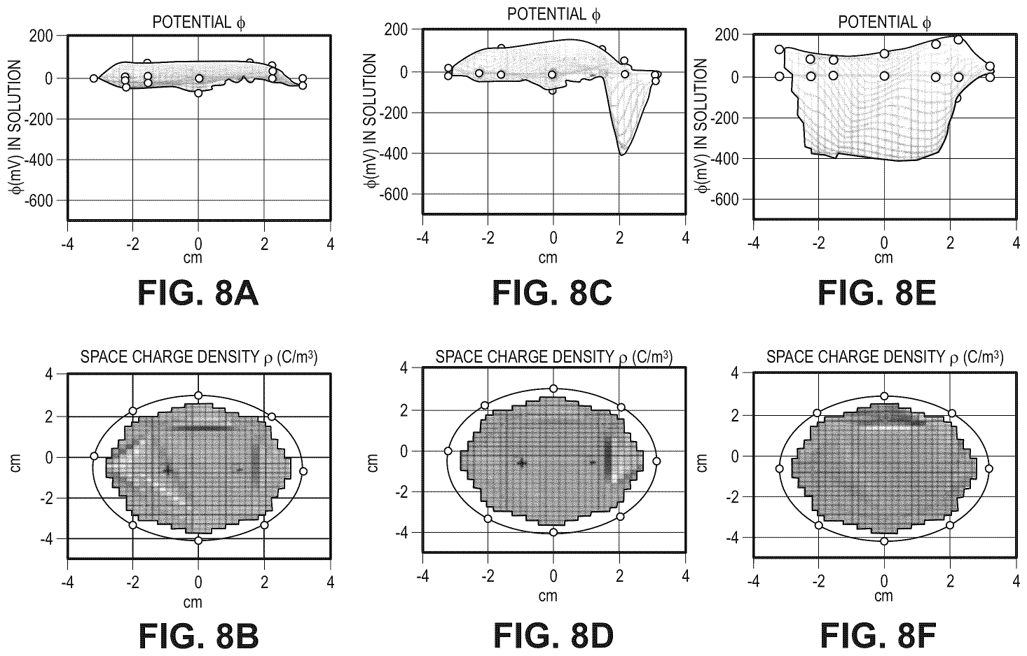

FIGS. 8A-8F are a series of graphs illustrating the effects of HVE dipole on/off and switch polarity for an example utilizing high voltage contactless electrodes (HVE) in a dipole field configuration using non-invasive probes (electric field emitters), in accordance with the present disclosure. Experiment results shown in FIGS. 8A-8F are for a thin film sol-gel synthesis using 1M TEOS, 0.1M HCl in ethanol. In FIGS. 8A and 8B, no electric field is applied, in FIGS. 8C and 8D, 5 kV/2.2 cm is applied and charge density migrates to the cathode and stays there as long as the field is applied. FIGS. 8E and 8F, flipping the applied electric field polarity twice induces a torque on the solution consistent with Lenz's law. Thus, rotating the location of the charge density. These experiment results prove that HVE can modulate pH and induce or restrict ion mobility of a wet chemical reaction using non-evasive electric field emitters.

PotMap measurements demonstrate contactless HVE ion redistribution. LNB strata form as a functional of potential RH(ψ) called the HVE polymerization functional. Biform sol-gel f(Σ_{L}) functional of manifold solubility n_{∂L}^{o}/ρ_{∂L}^{o} in-between pseudo interfacial surfaces is cathodic low f_{∂C} or anodic high f_{∂A}. MPB model zero potential boundary conditions on the bottom and sides of the sol-gel volume are likely the reason for producing the potential dip centered toward the middle of the probes, rather than as PotMap measured with the peak clearly near cathode. pH was calculated using ρ_{∂L}^{o H+}=[100 mM] exp (−e ψ/kT)knowin g catalyst concentration as 0.1 M HC1. HVE induces pH swings near cathode of more than construction 5.5 pH, as shown in FIGS. 8C and 8D, in comparison with IFGS. 8A and 8B. Utilizing a power supply that could bias the anode with large positive voltages the pH could be swung as much in the opposite direction.

HVE induces potential ψ in the sol-gel that can modeled using steric effect MPB. HVE causes pseudo interfacial surfaces of isopotential to form in the sol-gel. Ions to stratify along bands of isopotential surfaces and localize condensation pathways functionals of solubility in the local neutral band (LNB). HVE induces solubility changes by changing ion concentration and configuration entropy silica and surfactants and molar ratios of solvent, catalyst, surfactant, and silica. Concentration gradients are then imprinted into the sol-gel with the HVE. HVE engineering processes of the present disclosure can create sol-gel structures and pattern nanoparticle formation using directed electric field effects. Gradients of ion concentration produce drastically different solubility conditions in the sol-gel, and thus reaction depletion areas form and fossilize the electric field pattern.

Stöber nanoparticle and mesoporous silica particles have been synthesized in basic conditions with and without the HVE. Under constant mixing contactless electric field increases sol-gel solution potential ψ, broadens EDL overlap, increases ionic concentration, reduces silica and surfactant solubility, and enhances steric stabilization effects during condensation. Many variations of silica thin films have been synthesized in acidic and basic conditions using HVE as described herein. The contactless electric field produced space charge density gradients that localized silica and surfactant solubility and distinctly oriented siloxane polymerization.

Electric fields can non-evasively modulate silica sol-gel reactions without inserting probes or electrodes into solution. The applied electric field increases space charge density of similar species and limits ion mobility during sol-gel condensation. This changes the nature of the sol-gel products formed. The electric field can order silica condensation to enhance axial polymerization, increase ionic steric stabilization, inhibit siloxane bonding and reesterfication. Increased space charge density can decrease siloxane solubility reducing the likelihood depolymerization. The sol-gel process can be controlled by the electric field intensity, orientation, and timing. HVE electric field intensities ranging from 400V/5.0 cm to about 6 kV/5.0 cm for durations of 30 seconds to 48 hours have been experimentally demonstrated as useful for sol-gel product synthesis.

The effect of the applied electric field in the solution is to redistribute the charge density. This silica sol-gel control process with electric fields can non-evasively produce silica products that are normally entropically unfavorable. This is accomplished by polarizing the space charge density in solution causing an increase in internal energy of the system. Space charge is an excess free charge continuum concept pertaining to charge carrier generation in dielectric media such as sol-gel intermediates, e.g., Si—OH2+, Si—O—, H+, OH—. The increased internal energy of the system is expressed in terms of aggregation of similarly charged silica species. The resulting silica products are therefore locally unique to their electrochemical strata concentrations catalyst, reactants, and solvents. This solgel control process can produce silica products with drastically different macro and nano scale features within the same sol-gel solution. Sol-gel condensation occurs within stratified layers of space charge density created by an applied electric field. Layers of equal space charge densities form along isopotential surfaces normal to the electric field in solution.

Advantages of the methods and systems described herein provide a process wherein the electric field will redistribute ions during sol-gel condensation and serves to concentrate similar ions and increase ionic steric stabilization, form stratified layers of space charge density along isopotential layers made up of species of similar valency, and provide a greater concentration of ionic silica species concentrated in between adjacent nuclei and enhanced condensation of the silica, in an induced hybrid particle-gel action. In certain examples, in acidic conditions near the cathode, hydronium ion aggregation increases surface charge density and reduces solubility of siloxane species, which limits Ostwald Ripening (flocculation). In certain examples, in acidic conditions near the anode, hydronium ion depletion reduces surface charge density and increases solubility of siloxane species. Certain surfactants, such as but not limited to surfactant Pluronic F127 have been shown to enhance solubility near the anode in an acidic medium. As a result, surfactant templating can be enhanced and laminar stabilize against siloxane bonding, while enhancing axial polymerization and preferentially form fibrillar sol-gel products.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of producing nanomaterials in a sol-gel process, comprising:
selecting at least one type of nanoparticle to be produced within a prepared solution;
placing high voltage contactless electrodes in a pre-selected configuration that forms the selected at least one type of nanoparticle, the high voltage contactless electrodes includes at least one anode and one cathode;
providing the prepared solution for application of an electric field via high voltage contactless electrodes without direct contact with the anode and the cathode; and
providing a voltage to the high voltage contactless electrodes; and
producing the at least one type of nanoparticle within the prepared solution.

2. The method of claim 1, wherein the at least one type of nanoparticle is a nanorod.

3. The method of claim 1, wherein the at least one type of nanoparticle comprises silicon dioxide.

4. The method of claim 1, wherein the at least one type of nanoparticle comprises iron oxide.

5. The method of claim 1, wherein the pre-selected configuration of high voltage contactless electrodes is a transverse electric field configuration.

6. The method of claim 1, wherein the pre-selected configuration of high voltage contactless electrodes is a perpendicular electric field configuration.

7. A method of controlling production of nanomaterials in a sol-gel process, comprising:
providing an electric field control device having an anode and a cathode;
exerting an electric field via the electric field control device to a colloidal solution without having direct physical contact between the anode and cathode to the colloidal solution; and
forming nanoparticles in the colloidal solution.

8. The method of claim 7, wherein the electric field control device is high voltage contactless electrodes in a transverse electric field configuration.

9. The method of claim 7, wherein the electric field control device is high voltage contactless electrodes in a perpendicular electric field configuration.

10. A nanomaterial formed by the method of claim 7, wherein the nanomaterial is a plurality of nanorods.

11. A nanomaterial formed by the method of claim 7, wherein the nanomaterial comprises silicon dioxide, iron oxide, or a combination thereof.

12. A system for producing nanomaterials, comprising:
high voltage contactless electrodes comprising:
a high voltage power supply;
an anode connected to the high voltage power supply; and
a cathode connected to the high voltage power supply;
a reaction vessel configured to contain a reaction media; and
a dielectric media between the high voltage contactless electrodes and the reaction vessel.

13. The system for producing nanomaterials of claim 12, wherein the dielectric media is air.

14. The system for producing nanomaterials of claim 12, wherein the reaction media comprises a sol gel precursor.

15. The system for producing nanomaterials of claim 12, further comprising an agitation device.

16. The system for producing nanomaterials of claim 15, wherein the agitation device is a rotational stage, a translational stage, a stirring apparatus, or a combination thereof

17. The system for producing nanomaterials of claim 13, wherein the anode and cathode are arranged perpendicular to the reaction vessel.

18. The system for producing nanomaterials of claim 13, wherein the anode and cathode are arranged on opposite sides of the reaction vessel.

19. The system for producing nanomaterials of claim 13, further comprising:
an array of anodes; and
an array of cathodes.

20. The system for producing nanomaterials of claim 13, wherein the high voltage power supply emits an electric field from about 400V/5.0 cm to about 6 kV/2.2 cm.
